(19) United States
(12) Patent Application Publication
(10) Pub. No.: US 2024/0290537 A1
(43) Pub. Date: Aug. 29, 2024

(54) POWER INDUCTOR AND PREPARATION METHOD THEREFOR

(71) Applicant: HENGDIAN GROUP DMEGC MAGNETICS CO., LTD, Dongyang City Jinhua, Zhejiang (CN)

(72) Inventors: Yangdong YU, Dongyang City Jinhua, Zhejiang (CN); Leijie WANG, Dongyang City Jinhua, Zhejiang (CN); Quan ZHU, Dongyang City Jinhua, Zhejiang (CN); Jianyu CHEN, Dongyang City Jinhua, Zhejiang (CN); Kang YI, Dongyang City Jinhua, Zhejiang (CN)

(21) Appl. No.: 18/569,201

(22) PCT Filed: Oct. 14, 2022
(86) PCT No.: PCT/CN2022/125323

§ 371 Date: Dec. 11, 2023

(30) Foreign Application Priority Data
Nov. 30, 2021 (CN) 202111440523.4

(51) Int. Cl. H01F 41/02; H01F 41/00; H01F 41/063

(52) U.S. Cl. CPC H01F 41/0246; H01F 41/005; H01F 41/063

(57) ABSTRACT

Provided in the present application are a power inductor and a preparation method therefor. The preparation method comprises the process steps of slurry preparation, slurry casting, coil winding, coil arrangement, slurry pouring, warm-water pressing, curing treatment, UV adhesive film lamination, cutting, etc. A small-size power inductor can be simply and efficiently prepared, the preparation method is particularly suitable for ultrathin inductors, the phenomena of a short circuit, an open circuit, etc., appearing due to the damage to copper wires that is caused by using dry-pressing integral forming technology are avoided, and the problem of a single box body being easily damaged during casting is solved, thereby facilitating industrial applications.

### TECHNICAL FIELD

The present application belongs to the technical field of electronic components, and specifically relates to a power inductor and a preparation method therefor.

### BACKGROUND

With the rapid development of science and technology, the requirements for the performance and reliability of electronic products are becoming more and more stringent. Inductors, as one of the three passive components of electronic circuits, play a role in filtering, oscillation, filtering noise, stabilizing current and suppressing electromagnetic interference in the circuit. As the technology is developing rapidly nowadays, the inductor is required to bear larger current and frequency. The conventional dry pressing integral molding inductor requires a large molding pressure, which is easy to lead to large deformation of the internal coil of the inductor, and damage the insulating paint on the surface of the copper wire and in turn causes open circuit and short circuit during the pressing process. This phenomenon is common in the production of small-size power inductors of less than or equal to 2.0×2.0 mm, because the copper wire used in the coil of such inductor is very thin and the insulating paint around the copper wire is thin. In addition, the dry pressing molding process has high requirements for molding equipment and molds, and due to the tonnage of the press and the mold design, the production efficiency of the product is limited, and the production cost of the inductor is also high. Moreover, the ultra-thin inductor with a height of less than or equal to 0.6 m are difficult to be manufactured with the conventional dry pressing integral molding process. Therefore, it is of great significance to reduce the difficulty and production cost of power inductors.

CN213752214U discloses a pouring inductor, and the pouring inductor is composed of a box molded by pressing a magnetic powder, a conductor coil and a magnetic slurry poured in the box. The inductor of the utility model patent is molded by pouring without pressing the coil, avoiding the deformation of the coil and magnetic leakage effectively. However, the utility model patent adopts the method of first pressing a magnetic powder to mold a box, and then arranging a coil in the box separately and pouring; the process is complicated, and the production efficiency is low. When producing miniature inductors, the box wall is thin and easy to break during assembly, which is not suitable for mass production.

CN107731452A discloses a pouring inductor, wherein the pouring inductor is composed of a soft magnetic powder composite material, a coil and a potting box. The coil is centered in the potting box, and the soft magnetic powder composite material, the coil and the potting box are molded by integral pouring. The soft magnetic powder composite material is prepared from a soft magnetic powder, a passivator, an insulator, an adhesive and a dilution solvent, wherein the soft magnetic powder is one or more compositions of an iron-silicon-aluminum powder, an iron-silicon powder, an iron powder, an amorphous nanocrystalline powder and a ferrite powder. CN107731452A also discloses a method for preparing the pouring inductor, but this method also has the above problems.

In summary, the present application provides a method for quickly and efficiently preparing small-size power inductors, which can avoid defects such as short circuit and open circuit of the inductor coil caused by damage to the copper wire due to large molding pressure.

### SUMMARY

The following is a summary of the subject described in detail herein. This summary is not intended to limit the protection scope of the claims.

In view of the problems of the prior art, an object of the present application is to provide a power inductor and a preparation method therefor. The preparation method adopts the process of integral pouring followed by cutting to prepare small size (less than or equal to 2 mm in size) power inductors on a large scale, which is especially suitable for the preparation of ultra-thin (less than or equal to 1.6 mm) inductors, avoiding open circuit and short circuit caused by dry pressing integrated molding technology, and greatly improving production efficiency, and it is conducive to industrial applications.

In order to achieve the object, the present application adopts the following technical solutions.

In a first aspect, the present application provides a method for preparing a power inductor, and the preparation method comprises the following steps:
(1) coil arrangement: sticking hollow coils onto a thermosensitive adhesive film at equal spacing;
(2) slurry pouring: installing a pouring mold above the thermosensitive adhesive film, injecting a magnetic slurry and drying to obtain a pouring body which forms a first structure with the pouring mold, and separating the first structure from the thermosensitive adhesive film;
(3) warm-water pressing and curing treatment: sticking a casting magnetic sheet onto a side of the first structure which the thermosensitive adhesive film is separated from, and then subjecting the first structure to warm-water pressing and curing treatment in turn;
(4) separating the pouring body from the pouring mold to obtain a pouring body provided with a casting magnetic sheet, which is as a second structure, and cutting the second structure to obtain an inductor unit; and
(5) preparing a power inductor from the inductor unit.

In the present application, in view of the shortcomings of the mold-compressing integral molding process, the preparation method adopts the technology of integral pouring following by cutting to solve the problem that the thin box wall is easy to be damaged during the production of a single component, which is especially suitable for the preparation of ultra-thin inductors; in addition, in the present application, by using the technology of warm-water pressing+curing treatment, a required molding pressure is effectively reduced, and the applied pressure is more uniform, solving the technical problems in the prior art such as high required molding pressure, high requirements for molding equipment, and short circuit and open circuit caused by the damage of copper wire due to large molding pressure. The preparation method greatly improves production efficiency and is suitable for mass production.

The following is preferred technical solutions of the present application, but not a limitation of the technical solutions provided by the present application. Through the following technical solutions, the technical objects and beneficial effects of the present application can be better achieved.

As a preferred technical solution of the present application, the hollow coils in step (1) are obtained by winding copper wires.

Optionally, the hollow coils in step (1) have an upper layer and a lower layer, and each layer has more than or equal to 1 turn, such as 1 turn, 2.5 turns, 3 turns, 4 turns, 4.5 turns, 5 turns or 5.5 turns, etc.; however, the number of turns is not limited to the listed values, and other unlisted values within this value range are also applicable. Two ends of the copper wire used for winding are respectively located at different layers and leaded outward to form leading-out terminals.

Optionally, the leading-out terminals are perpendicular to respective leading-out surfaces and arranged on opposite sides.

Optionally, the leading-out terminals have a leading-out length of 0.02-0.2 mm, such as 0.02 mm, 0.04 mm, 0.06 mm, 0.08 mm, 0.1 mm, 0.12 mm, 0.14 mm, 0.18 mm or 0.2 mm, etc.; however, the leading-out length is not limited to the listed values, and other unlisted values within this value range are also applicable.

Optionally, the copper wire comprises a copper wire coated with insulating paint.

Optionally, the insulating paint has a thickness of 2-8 μm, such as 2 μm, 4 μm, 6 μm or 8 μm, etc.; however, the thickness is not limited to the listed values, and other unlisted values within this value range are also applicable.

Optionally, a cross-section of the copper wire is rectangular in shape.

Optionally, the copper wire has a thickness of 0.03-0.08 mm, such as 0.03 mm, 0.04 mm, 0.05 mm, 0.06 mm, 0.07 mm or 0.08 mm, etc.; however, the thickness is not limited to the listed values, and other unlisted values within this value range are also applicable.

Optionally, the copper wire has a width of 0.1-0.25 mm, such as 0.1 mm, 0.15 mm, 0.2 mm or 0.25 mm, etc.; however, the width is not limited to the listed values, and other unlisted values within this value range are also applicable.

Optionally, the copper wire has a width-to-thickness ratio of 2-4, such as 2, 3 or 4, etc.; however, the width-to-thickness ratio is not limited to the listed values, and other unlisted values within this value range are also applicable.

In the present application, while taking into account the inductor size, controlling the width-to-thickness ratio can reduce the copper loss of the coil. The thinner the thickness of the copper wire, the more turns can be wound in a limited space, thereby effectively increasing the inductance value; moreover, an appropriate increase in the width of the copper wire can increase the cross-sectional area of the copper wire and reduce the copper loss, thereby effectively improving the efficiency of the inductor.

As a preferred technical solution of the present application, the thermosensitive adhesive film stuck with coils in step (1) is fixed on a holder.

Optionally, the holder comprises a fixable plate and a base.

Optionally, the thermosensitive adhesive film in step (1) is fixed on the fixable plate with an adhesive side facing up.

Optionally, a material of the fixable plate comprises stainless steel.

Optionally, the fixable plate has a thickness of 0.2-0.5 mm, such as 0.2 mm, 0.3 mm, 0.4 mm or 0.5 mm, etc.; however, the thickness is not limited to the listed values, and other unlisted values within this value range are also applicable.

Optionally, the fixable plate is square in shape and independently provided with fixable plate locating holes at four corners.

Optionally, the fixable plate is fixed on the base.

Optionally, the base is square in shape and independently provided with locating pins at four corners.

In the present application, the locating holes of the fixable plate are perfectly fitted to the locating pins of the base, so as to achieve fixation.

Optionally, the surface of the base is provided with horizontal and vertical gridlines.

In the present application, an equidistant arrangement of the coils is realized by the gridlines of the base. Intersections of the gridlines can be used as “marker” points of an arrangement machine when arranging the coils, so that the coils can be arranged at a required equal interval.

As a preferred technical solution of the present application, the pouring mold in step (2) is square in shape, and independently provided with mold locating holes at four corners.

In the present application, the locating holes of the mold are also perfectly fitted to the locating pins of the base, and the bottom of the pouring mold is stuck to the thermosensitive adhesive film after installation.

A depth of the mold can be calculated from a thickness of the power inductor to be prepared and a shrinkage rate of the slurry.

Optionally, a method for preparing the magnetic slurry in step (2) comprises: mixing a Fe—Si—Al powder and an amorphous powder to obtain a composite soft magnetic alloy powder; then mixing the composite soft magnetic alloy powder, epoxy resin, an organic solvent and a curing agent to obtain a magnetic slurry.

Optionally, the Fe—Si—Al powder and the amorphous powder are independently subjected to coating treatment before mixing.

In the present application, steps of the coating treatment comprise: low-temperature annealing, phosphating treatment, drying, sieving and other regular operations.

Optionally, the Fe—Si—Al powder has a particle size of 20-30 μm, such as 20 μm, 22 μm, 24 μm, 26 μm, 28 μm or 30 μm, etc.; however, the particle size is not limited to the listed values, and other unlisted values within this value range are also applicable.

Optionally, the amorphous powder comprises a Fe—Si—B—Cr powder.

Optionally, the amorphous powder has a particle size of 4-8 μm, such as 4 μm, 5 μm, 6 μm, 7 μm or 8 μm, etc.; however, the particle size is not limited to the listed values, and other unlisted values within this value range are also applicable.

Optionally, the Fe—Si—Al powder and the amorphous powder has a mass ratio of (7-9):(3-1), such as 7:3, 8:2 or 9:1, etc.; however, the particle size is not limited to the listed values, and other unlisted values within this value range are also applicable.

Optionally, raw materials of the magnetic slurry comprise by weight:
1000 parts of the composite soft magnetic alloy powder;
25-40 parts of epoxy resin, such as 25 parts, 27 parts, 30 parts, 33 parts, 37 parts or 40 parts, etc.;
75-100 parts of an organic solvent, such as 75 parts, 80 parts, 85 parts, 90 parts, 95 parts or 100 parts, etc.; and
6-10 parts of a curing agent, such as 6 parts, 7 parts, 8 parts, 9 parts or 10 parts, etc.; however, the weight parts are not limited to the listed values, and other unlisted values within the value ranges are also applicable.

In the present application, the raw material ratio of the magnetic slurry has a certain influence on the performance of the power inductor. Too much content of the epoxy resin, organic solvent and curing agent will lead to low inductance value and fail to meet the use requirements; if the content of the epoxy resin, organic solvent and curing agent is too low, the casting magnetic sheet will have poor strength and be easy to break.

Optionally, the epoxy resin comprises bisphenol A epoxy resin or bisphenol F epoxy resin.

Optionally, the epoxy resin has an epoxy equivalent of 180-190 g/eq, such as 180 g/eq, 182 g/eq, 184 g/eq, 186 g/eq, 188 g/eq or 190 g/eq, etc.; however, the epoxy equivalent is not limited to the listed values, and other unlisted values within this value range are also applicable.

Optionally, the epoxy resin at room temperature has a viscosity of 11000-13000 MPa·s, such as 11000 MPa·s, 11500 MPa·s, 12000 MPa·s, 12500 MPa·s or 13000 Mpa·s, etc.; however, the viscosity is not limited to the listed values, and other unlisted values within this value range are also applicable.

Optionally, the organic solvent comprises any one or a combination of at least two of ethyl acetate, n-propanol, isopropanol or ethanol, and typical but non-limiting examples of the combination comprise: a combination of n-propanol and isopropanol, a combination of n-propanol and ethanol, a combination of ethyl acetate and ethanol, etc., preferably a combination of ethyl acetate and n-propanol.

In the present application, in a case where a combination of ethyl acetate and n-propanol is selected, the two are mixed at a mass ratio of 1:1.

Optionally, the curing agent comprises any one or a combination of at least two of ethylenediamine, diethylenetriamine, diethyltoluenediamine or dicyandiamide, and typical but non-limiting examples of the combination comprise: a combination of ethylenediamine and diethylenetriamine, a combination of diethyltoluenediamine and dicyandiamide, etc., preferably diethyltoluenediamine.

Optionally, a mixing method of the magnetic slurry comprises ball milling.

Optionally, a medium of the ball milling comprises zirconium balls.

Optionally, the zirconium balls comprise a zirconium ball with a diameter of 15-20 mm and a zirconium ball with a diameter of 5-10 mm.

In the present application, two types of zirconium balls with different diameters have a mass ratio of 1:1, and a total weight of 2000-3000 parts.

In the present application, a more specific mixing process of the magnetic slurry comprises: firstly, adding the above zirconium balls, composite soft magnetic alloy powder and organic solvent into a ball mill for mixing for 1-2 h, then adding epoxy resin for ball milling for 6-12 h, and then adding a curing agent and continuing to perform ball milling for 0.5-2 h, and then discharging a material; before entering a next process, performing vacuum degassing and testing a viscosity of the slurry. A speed of the ball mill is calculated and controlled suitably according to a diameter of a ball mill tank, and an object of the ball milling in the present application is uniform mixing.

Optionally, the magnetic slurry has a viscosity of 10000-15000 MPa·s, such as 10000 MPa·s, 11000 MPa·s, 12000 Mpa·s, 13000 Mpa·s, 14000 MPa·s or 15000 Mpa·s, etc.; however, the viscosity is not limited to the listed values, and other unlisted values within this value range are also applicable.

As a preferred technical solution of the present application, the drying in step (2) is performed at 60-100° C., such as 60° C., 70° C., 80° C., 90° C. or 100° C., etc.; however, the temperature is not limited to the listed values, and other unlisted values within this value range are also applicable.

Optionally, the drying in step (2) is performed for 3-6 h, such as 3 h, 4 h, 5 h, or 6 h, etc.; however, the time is not limited to the listed values, and other unlisted values within this value range are also applicable.

In the present application, an object of the low-temperature drying in step (2) is, on the one hand, to fully volatilize the solvent, and on the other hand, to let the epoxy resin undergo a partial curing reaction. After the slurry is dry, the first structure, fixable plate, and base are separated out, and then the fixable plate and thermosensitive adhesive film are separated from the first structure at 110-135° C.

As a preferred technical solution of the present application, a specific method for preparing the casting magnetic sheet in step (3) comprises: coating a magnetic slurry on a base film by a casting machine, then drying, and separating the dried magnetic slurry from the base film to form a casting magnetic sheet.

In the present application, more specific operations for preparing the casting magnetic sheet comprise: injecting the prepared magnetic slurry into a barrel, and then introducing dry high-pressure nitrogen into the sealed barrel with controlling a nitrogen pressure at 0.5±0.1 MPa, injecting the slurry in the barrel into a casting machine trough under a high-pressure nitrogen pressure, opening or closing a feeding valve by a liquid level controller to ensure that a liquid level of the slurry in the trough is controlled in the range of 40±2 mm; coating the slurry in the trough on a base film evenly after passing through a blade with appropriate spacing set for casting.

Before casting, the spacing between a casting blade and a PET base film can be calculated according to an expected thickness of the magnetic sheet divided by a shrinkage rate of the slurry, and then the thickness of the magnetic sheet can be controlled by adjusting the spacing between the blade and the base film.

Optionally, the base film comprises a PET base film.

Optionally, a manner of the drying comprises baking.

Optionally, the baking is performed at 30-120° C., such as 30° C., 40° C., 50° C., 60° C., 70° C., 80° C., 90° C., 100° C., 110° C. or 120° C., etc.; however, the temperature is not limited to the listed values, and other unlisted values within this value range are also applicable.

Optionally, the casting magnetic sheet has a thickness of 0.05-0.5 mm, such as 0.05 mm, 0.1 mm, 0.2 mm, 0.3 mm, 0.4 mm or 0.5 mm, etc.; however, the thickness is not limited to the listed values, and other unlisted values within this value range are also applicable.

As a preferred technical solution of the present application, the first structure in step (3) is subjected to vacuum sealing before the warm-water pressing.

Optionally, the warm-water pressing in step (3) is performed at 70-90° C., such as 70° C., 75° C., 80° C., 85° C. or 90° C., etc.; however, the temperature is not limited to the listed values, and other unlisted values within this value range are also applicable.

Optionally, the warm-water pressing in step (3) is performed at 20-40 MPa, such as 20 MPa, 22 MPa, 24 MPa, 26 MPa, 28 MPa, 30 MPa, 35 MPa or 40 MPa, etc.; however, the pressure is not limited to the listed values, and other unlisted values within this value range are also applicable.

Optionally, the warm-water pressing in step (3) is performed for 30-60 min, such as 30 min, 35 min, 40 min, 45 min, 50 min, 55 min or 60 min, etc.; however, the time is not limited to the listed values, and other unlisted values within this value range are also applicable.

Optionally, the curing treatment in step (3) is performed at 140-220° C., such as 140° C., 150° C., 160° C., 170° C., 180° C., 190° C., 200° C., 210° C. or 220° C., etc.; however, the temperature is not limited to the listed values, and other unlisted values within this value range are also applicable.

Optionally, the curing treatment in step (3) is performed for 2-4 h, such as 2 h, 2.5 h, 3 h, 3.5 h, or 4 h, etc.; however, the time is not limited to the listed values, and other unlisted values within this value range are also applicable.

As a preferred technical solution of the present application, cutting lines are printed on the surface of the pouring body before the separation in step (4).

Optionally, a specification size of the cutting lines is the same as the gridlines on the surface of the base.

Optionally, before the cutting, a UV film is stuck on a side of the second structure which is provide with the casting magnetic sheet.

In the present application, the inductor unit cut off shall ensure that the leading-out terminals at two ends protrude out of the surface of two sides of the inductor unit.

As a preferred technical solution of the present application, a specific operation of step (5) comprises: coating the surface of the inductor unit, and then assembling an external electrode to obtain a power inductor.

In the present application, coating and assembling an external electrode are routine operations in the field, which will not be elaborated here. A preparation process of the external electrode is the same as that of common inductors.

In a second aspect, the present application provides a power inductor prepared by the preparation method according to the first aspect.

Compared with the prior art, the present application has the following beneficial effects.

In view of the shortcomings of the mold-compressing integral molding process, the preparation method in the present application adopts the technology of integral pouring followed by cutting to solve the problem that the thin box wall is easy to be damaged during the production of a single component, which is especially suitable for the preparation of ultra-thin inductors; in addition, in the present application, by using the technology of warm-water pressing+curing treatment, a required molding pressure is effectively reduced, and the applied pressure is more uniform, solving the technical problems in the prior art such as high required molding pressure, high requirements for molding equipment and short circuit and open circuit caused by the damage of copper wire due to large molding pressure; the preparation method greatly improves production efficiency and is suitable for mass production; in addition, the prepared power inductor has an inductance value L of 1±20% pH, and the direct current resistance value Rdc of less than or equal to 160 mΩ, or even less than or equal to 60 mΩ.

After reading and understanding the drawings and detailed descriptions, other aspects can be understood.

### BRIEF DESCRIPTION OF DRAWINGS

FIG. 1 is a structural schematic diagram of a fixable plate provided in the present application.

FIG. 2 is a structural schematic diagram of a base provided in the present application.

FIG. 3 is a structural schematic diagram of a pouring mold provided in the present application.

FIG. 4 is a structural schematic diagram of a hollow coil provided in Example 1 of the present application.

FIG. 5 is a structural schematic diagram of a thermosensitive adhesive film and a fixable plate provided which are bonded together in Example 1 of the present application.

FIG. 6 is an assembly structural schematic diagram of a thermosensitive adhesive film, a fixable plate and a base provided in Example 1 of the present application.

FIG. 7 is an assembly structural schematic diagram of hollow coils, a thermosensitive adhesive film, a fixable plate, a base and a pouring mold provided in Example 1 of the present application.

FIG. 8 is a structural schematic diagram of an inductor unit provided in Example 1 of the present application.

FIG. 9 is a structural schematic diagram of a power inductor provided in Example 1 of the present application.

Reference lists: 1—fixable plate, 11—fixable plate locating hole, 2—base, 21—base locating pin, 22—gridline, 3—pouring mold, 31—mold locating hole, 4—hollow coil, 41—leading—out terminal, 5—thermosensitive adhesive film, 6—pouring body, 7—inductor unit, 8—power inductor, 9—external electrode.

### DETAILED DESCRIPTION

In order to more clearly illustrate the present application and facilitate the understanding of technical solutions in the present application, the present application is further described in detail below. However, the following examples are only simple examples of the present application and do not represent or limit the protection scope of the present application, and the extent of protection for the present application shall be determined by the terms of the claims.

Tools and equipment used in the following examples and comparative examples are as follows.
(1) Holder, comprising a fixable plate 1 and a base 2

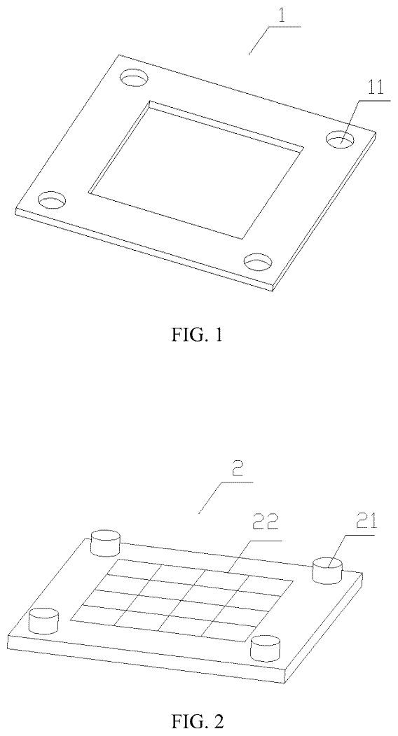

The fixable plate 1 is square in shape with a material of stainless steel and a thickness of 0.4 mm, and independently provided with fixable plate locating holes 11 at four corners; a structural schematic diagram of the fixable plate 1 is shown in FIG. 1.

The base 2 is square in shape and independently provided with locating pins at four corners, and the surface of the base 2 is provided with horizontal and vertical gridlines 22; a structural schematic diagram of the base 2 is shown in FIG. 2.
(2) Pouring mold 3

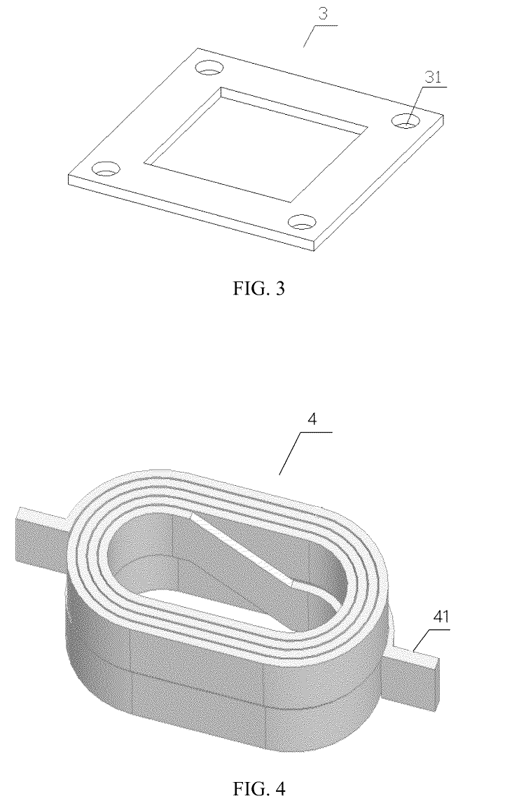

The pouring mold 3 is square in shape, and independently provided with mold locating holes 31 at four corners; a structural schematic diagram of the pouring mold 3 is shown in FIG. 3.

The following are typical but non-limiting examples of the present application.

### Example 1

This example provides a power inductor and a preparation method therefor, and the preparation method comprises the following steps.

Preparing a magnetic slurry: a Fe—Si—Al powder with an average particle size of 25.6 μm and a Fe—Si—B—Cr amorphous powder with an average particle size of 7.26 μm were subjected to coating treatment and then mixed evenly according to a mass ratio of 7:3 to obtain a composite soft magnetic alloy powder;
based on a weight of the composite soft magnetic alloy powder being 1000 parts, a magnetic slurry was prepared from the composite soft magnetic alloy powder, 30 parts of bisphenol F type epoxy resin, 80 parts of ethyl acetate and n-propanol (a mass ratio of 1:1) and 7.5 parts of diethyltoluenediamine, and added with a total weight of 2000 parts of zirconium balls with diameters of 15 mm and 5 mm, where a mass ratio of the two different zirconium balls was 1:1;
a mixing process of the magnetic slurry is that the zirconium balls, composite soft magnetic alloy powder, ethyl acetate and n-propanol were first added into a ball mill and mixed for 2 h, then added with bisphenol F epoxy resin and subjected to ball milling for 8 h, and then added with diethyltoluenediamine and continued to undergo ball milling for 0.5 h to discharge a material; vacuum degassing was performed after discharging and a viscosity of the slurry was tested; the viscosity was 12754 MPa·s, and a speed of the ball milling was 120 r/min.

Preparing a casting magnetic sheet: the magnetic slurry was injected into a barrel, and then dry high-pressure nitrogen was introduced into the sealed barrel with controlling a nitrogen pressure at 0.5 MPa, and by a liquid level controller, a feeding valve was opened or closed to ensure that a liquid level of the slurry in a trough was controlled in the range of 40±2 mm; the slurry in the trough was uniformly coated on a PET base film after passing through a blade with appropriate spacing by casting, and baked via a baking tunnel of a casting machine, and a temperature of the baking tunnel was set as four temperature zones of 30° C., 50° C., 90° C. and 60° C.; the solvent of the magnetic slurry on the PET base film was gradually volatilized completely at the high-temperature baking tunnel, and the magnetic slurry was formed into a casting magnetic sheet; a thickness of the obtained casting magnetic sheet was 0.21 mm, and a magnetic permeability u of the cast magnetic sheet was tested to be 30.4 at a frequency of 1 MHz.

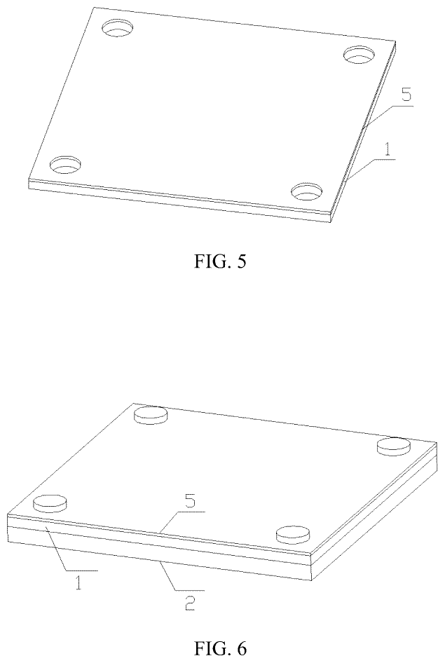

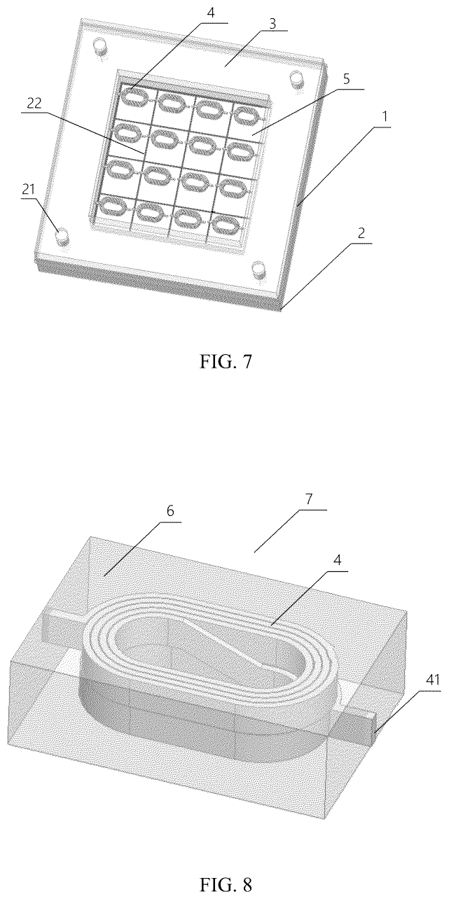

Preparing a hollow coil 4: a copper wire was wound into a hollow coil 4 by a winding machine, the hollow coil 4 had two layers, and each layer had 4.25 turns, two ends of the copper wire used for winding were respectively located at different layers and leaded outward to form leading-out terminals 41; a length of each leading-out terminal 41 was 0.12 mm; the copper wire was a copper wire coated with insulating paint with a rectangular cross-section, the insulating paint had a thickness of 3 μm, the copper wire had a thickness of 0.07 mm, a width of 0.20 mm and a width-to-thickness ratio of 2.86; a structural schematic diagram of the hollow coil 4 is shown in FIG. 4.
a. Coil arrangement: an adhesive side of a thermosensitive adhesive film 5 faced up, a back side was fixed on a fixable plate 1 by a double-sided tape, the fixable plate 1 was fixed on a base 2, and the hollow coils 4 (16) were stuck onto the thermosensitive adhesive film 5 at equal spacing by an arrangement machine; a structural schematic diagram of the bonded thermosensitive adhesive film 5 and fixable plate 1 is shown in FIG. 5, and an assembly structural schematic diagram of the thermosensitive adhesive film 5, fixable plate 1 and base 2 is shown in FIG. 6.
b. Slurry pouring: a pouring mold 3 with an inner cavity depth of 0.64 mm was placed above the thermosensitive adhesive film 5, the pouring mold 3 was fixed by a base locating pin 21, and the bottom of the pouring mold 3 was stuck to the thermosensitive adhesive film 5; an assembly structural schematic diagram of the hollow coils 4, thermosensitive adhesive film 5, fixable plate 1, base 2 and pouring mold 3 is shown in FIG. 7;

the magnetic slurry was injected into the pouring mold 3 until filling up with its surface scraped flat, and placed in an oven for static baking at 80° C. for 4 h; after the magnetic slurry was dried, the obtained pouring body 6 formed a first structure with the pouring mold 3, and the first structure was separated from the thermosensitive adhesive film 5 at 115° C.
(3) Warm-water pressing+curing treatment: the casting magnetic sheet was stuck onto the thermosensitive adhesive-separated side of the first structure, and subjected to vacuum sealing, and then put into a isostatic press for warm-water pressing at a set pressure of 30 MPa and a set temperature of 80° C. for 40 min; after the warm-water isostatic-pressing, heat curing was performed at 180° C. for 4 h.
(4) The cured first structure was re-fixed to the base 2, and the surface of the pouring body 6 was printed with cutting lines with the same size as gridlines 22 on the surface of the base 2;

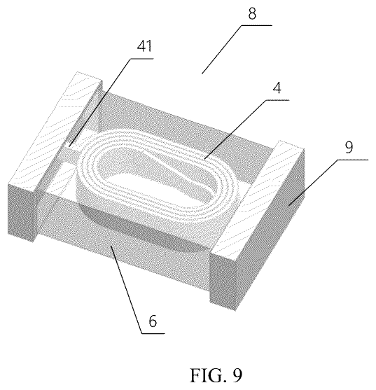

after printing, the pouring body 6 was separated from the pouring mold 3, and the obtained pouring body 6 provided with a casting magnetic sheet was a second structure, and a UV film was stuck onto the casting magnetic sheet-side of the second structure body, and then the second structure body was cut to obtain the inductor unit 7 (leading-out terminals 41 of the hollow coils 4 was ensured to be exposed on the surface of both side of the inductor unit 7); a structural schematic diagram of the inductor unit 7 is shown in FIG. 8.
(5) The surface of the inductor unit 7 was coated, and then an external electrode 9 was assembled to obtain a power inductor 8, and a structural schematic diagram of the power inductor 8 is shown in FIG. 9.

### Example 2

This example provides a power inductor and a preparation method therefor, the preparation method refers to the preparation method in Example 1, and the difference is as follows.

Preparing a magnetic slurry: a Fe—Si—Al powder with an average particle size of 28.8 μm and a Fe—Si—B—Cr amorphous powder with an average particle size of 7.64 μm were subjected to coating treatment and then mixed evenly according to a mass ratio of 9:1 to obtain a composite soft magnetic alloy powder; based on a weight of the composite soft magnetic alloy powder being 1000 parts, a magnetic slurry was prepared from the composite soft magnetic alloy powder, 30 parts of bisphenol A type epoxy resin, 80 parts of ethyl acetate and n-propanol (a mass ratio of 1:1) and 7.5 parts of diethyltoluenediamine; a viscosity of the obtained magnetic slurry was tested after vacuum degassing, and the viscosity was 13242 MPa·s.

Preparing a casting magnetic sheet: a thickness of the obtained casting magnetic sheet was 0.145 mm, and a magnetic permeability u of the casting magnetic sheet was tested to be 33.2 at a frequency of 1 MHz.

Preparing a hollow coil 4: a length of each leading-out terminal 41 was 0.04 mm; the copper wire had a thickness of 0.07 mm, a width of 0.18 mm and a width-to-thickness ratio of 2.57.
(2) Slurry pouring: an inner cavity depth of the pouring mold 3 was 0.7 mm; the magnetic slurry was placed in an oven and baked at 60° C. for 6 h; after the magnetic slurry was dried, the first structure was separated from the thermosensitive adhesive film 5 at 125° C.
(3) Warm-water pressing+curing treatment: the curing treatment was performed at 200° C. for 3 h.

### Example 3

This example provides a power inductor and a preparation method therefor, the preparation method refers to the preparation method in Example 1, and the difference is as follows.

Preparing a magnetic slurry: a Fe—Si—Al powder with an average particle size of 26.4 μm and a Fe—Si—B—Cr amorphous powder with an average particle size of 7.06 μm were subjected to coating treatment and then mixed evenly according to a mass ratio of 8:2 to obtain a composite soft magnetic alloy powder; based on a weight of the composite soft magnetic alloy powder being 1000 parts, a magnetic slurry was prepared from the composite soft magnetic alloy powder, 35 parts of bisphenol F type epoxy resin, 90 parts of ethyl acetate and n-propanol (a mass ratio of 1:1) and 8.75 parts of diethyltoluenediamine; a viscosity of the obtained magnetic slurry was tested after vacuum degassing, and the viscosity was 13624 MPa·s.

Preparing a casting magnetic sheet: a thickness of the obtained casting magnetic sheet was 0.225 mm, and a magnetic permeability u of the casting magnetic sheet was tested to be 31.8 at a frequency of 1 MHz.

Preparing a hollow coil 4: each layer had 3.75 turns, a length of each leading-out terminal 41 was 0.06 mm; the copper wire had a thickness of 0.06 mm, a width of 0.18 mm and a width-to-thickness ratio of 3.
(2) Slurry pouring: an inner cavity depth of the pouring mold 3 was 0.62 mm; the magnetic slurry was placed in an oven and baked at 90° C. for 3.5 h; after the magnetic slurry was dried, the first structure was separated from the thermosensitive adhesive film 5 at 125° C.
(3) Warm-water pressing+curing treatment: the curing treatment was performed at 220° C. for 2 h.

### Example 4

This example provides a power inductor and a preparation method therefor, the preparation method refers to the preparation method in Example 3, and the difference is as follows.

Preparing a casting magnetic sheet: a thickness of the obtained casting magnetic sheet was 0.170 mm, and a magnetic permeability u of the casting magnetic sheet was tested to be 32.1 at a frequency of 1 MHz.

Preparing a hollow coil 4: each layer had 5.5 turns, a length of each leading-out terminal 41 was 0.05 mm; the copper wire had a thickness of 0.05 mm, a width of 0.12 mm and a width-to-thickness ratio of 2.4.
(2) Slurry pouring: an inner cavity depth of the pouring mold 3 was 0.68 mm; the magnetic slurry was placed in an oven and baked at 95° C. for 3 h; after the magnetic slurry was dried, the first structure was separated from the thermosensitive adhesive film 5 at 120° C.
(3) Warm-water pressing+curing treatment: the curing treatment was performed at 200° C. for 4 h.

### Example 5

This example provides a power inductor and a preparation method therefor, the preparation method refers to the preparation method in Example 1, and the difference is as follows.

Preparing a magnetic slurry: based on a weight of the composite soft magnetic alloy powder being 1000 parts, a magnetic slurry was prepared from the composite soft magnetic alloy powder, 45 parts of bisphenol F type epoxy resin, 110 parts of ethyl acetate and n-propanol (a mass ratio of 1:1) and 11.25 parts of diethyltoluenediamine; a viscosity of the obtained magnetic slurry was tested after vacuum degassing, and the viscosity was 10813 MPa·s.

Preparing a casting magnetic sheet: a thickness of the obtained casting magnetic sheet was 0.215 mm, and a magnetic permeability u of the casting magnetic sheet was tested to be 21.8 at a frequency of 1 MHz.

### Example 6

This example provides a power inductor and a preparation method therefor, the preparation method refers to the preparation method in Example 2, and the difference is as follows.

Preparing a magnetic slurry: based on a weight of the composite soft magnetic alloy powder being 1000 parts, a magnetic slurry was prepared from the composite soft magnetic alloy powder, 20 parts of bisphenol A type epoxy resin, 70 parts of ethyl acetate and n-propanol (a mass ratio of 1:1) and 5 parts of diethyltoluenediamine; a viscosity of the obtained magnetic slurry was tested after vacuum degassing, and the viscosity was 12631 MPa·s.

Preparing a casting magnetic sheet: a thickness of the obtained casting magnetic sheet was 0.148 mm, and a magnetic permeability u of the casting magnetic sheet was tested to be 36.3 at a frequency of 1 MHz. When the casting magnetic sheet was peeled off from the PET base film after drying, the magnetic sheet had very poor strength and was easy to break, resulting in the inability to be rolled up.

This comparative example provides a method for preparing a power inductor, the preparation method refers to the preparation method in Example 1, and the difference is that the casting magnetic sheet is not prepared, that is, the casting magnetic sheet is not stuck to the first structure.

100 Batches of power inductors are respectively prepared by the preparation methods in Example 1-4 and Comparative Example 1, and their size, inductance performance L and DC resistance value Rdc are tested. The results are shown in Table 1.

TABLE 1

| | | Magnetic | | | | |
|---|---|---|---|---|---|---|
| | Magnetic | permeability μ | | Inductance | DC | |
| | powder | of magnetic | | performance | resistance | |
| | ratio | sheet | Size/mm | L | Rdc/mΩ | |
| Example 1 | 7:3 | 30.4 | 2.0 ± 0.2*1.6 ± 0.2*Max0.8 | 1 ± 20% μH | ≤60 | mΩ |
| Example 2 | 9:1 | 33.2 | 2.0 ± 0.2*1.2 ± 0.2*Max0.8 | 1 ± 20% μH | ≤80 | mΩ |
| Example 3 | 8:2 | 31.8 | 1.6 ± 0.2*0.8 ± 0.2*Max0.8 | 470 ± 20% nH | ≤65 | mΩ |
| Example 4 | 8:2 | 32.1 | 1.6 ± 0.2*0.8 ± 0.2*Max0.8 | 1 ± 20% μH | ≤160 | mΩ |
| Comparative | 6:4 | 21.8 | 2.0 ± 0.2*1.2 ± 0.2*Max0.8 | 671.2 nH | ≤60 | mΩ |

| | | | | | |
|---|---|---|---|---|---|
| Example 1 | | | | | |
| Comparative | 9:1 | 36.3 | — | — | — |
| Example 2 | | | | | |

The present application adopts the technology of integral pouring followed by cutting to produce small-size power inductors efficiently and rapidly, and the inductance performance L is up to 1 μH, and the DC resistance value is no more than 160 mΩ, which meet the use requirements.

The applicant declares that the present application illustrates products and detailed methods of the present application by the above examples, but the present application is not limited to the above products and detailed methods, that is, it does not mean that the present application must rely on the above products and detailed methods to be implemented. Those skilled in the art should understand that any improvement of the present application, the equivalent substitution of operations, the addition of auxiliary operations, the selection of specific methods in the present application shall fall within the scope of protection and disclosure of the present application.

What is claimed is:

1. A method for preparing a power inductor, comprising the following steps:
(1) coil arrangement: sticking hollow coils onto a thermosensitive adhesive film at equal spacing;
(2) slurry pouring: installing a pouring mold above the thermosensitive adhesive film, injecting a magnetic slurry and drying to obtain a pouring body which forms a first structure with the pouring mold, and separating the first structure from the thermosensitive adhesive film;
(3) warm-water pressing and curing treatment: sticking a casting magnetic sheet onto a side of the first structure which the thermosensitive adhesive film is separated from, and then subjecting the first structure to warm-water pressing and curing treatment in turn;
(4) separating the pouring body from the pouring mold to obtain a pouring body provided with a casting magnetic sheet, which is as a second structure, and cutting the second structure to obtain an inductor unit; and
(5) preparing a power inductor from the inductor unit.

2. The preparation method according to claim 1, wherein the hollow coils in step (1) are obtained by winding copper wires;
optionally, the hollow coils in step (1) have an upper layer and a lower layer, and each layer has more than or equal to 1 turn; two ends of the copper wire used for winding are respectively located at different layers and leaded outward to form leading-out terminals;
optionally, the leading-out terminals are perpendicular to respective leading-out surfaces and arranged on opposite sides;
optionally, the leading-out terminals have a leading-out length of 0.02-0.2 mm;
optionally, the copper wire comprises a copper wire coated with insulating paint;
optionally, the insulating paint has a thickness of 2-8 μm;
optionally, a cross-section of the copper wire is rectangular in shape;
optionally, the copper wire has a thickness of 0.03-0.08 mm;
optionally, the copper wire has a width of 0.1-0.25 mm;
optionally, the copper wire has a width-to-thickness ratio of 2-4.

3. The preparation method according to claim 1, wherein the thermosensitive adhesive film stuck with coils in step (1) is fixed on a holder;
optionally, the holder comprises a fixable plate and a base;
optionally, the thermosensitive adhesive film in step (1) is fixed on the fixable plate with an adhesive side facing up;
optionally, a material of the fixable plate comprises stainless steel;
optionally, the fixable plate has a thickness of 0.2-0.5 mm;
optionally, the fixable plate is square in shape and independently provided with fixable plate locating holes at four corners;
optionally, the fixable plate is fixed on the base;
optionally, the base is square in shape and independently provided with locating pins at four corners;
optionally, the surface of the base is provided with horizontal and vertical gridlines.

4. The preparation method according to claim 1, wherein the pouring mold in step (2) is square in shape, and independently provided with mold locating holes at four corners;
optionally, a method for preparing the magnetic slurry in step (2) comprises: mixing a Fe—Si—Al powder and an amorphous nanocrystalline powder to obtain a composite soft magnetic alloy powder; then mixing the composite soft magnetic alloy powder, epoxy resin, an organic solvent and a curing agent to obtain a magnetic slurry;
optionally, the Fe—Si—Al powder and the amorphous nanocrystalline powder are independently subjected to coating treatment before the mixing;
optionally, the Fe—Si—Al powder has a particle size of 20-30 μm;
optionally, the amorphous powder comprises a Fe—Si—B—Cr powder;
optionally, the amorphous powder has a particle size of 4-8 μm;
optionally, the Fe—Si—Al powder and the amorphous powder has a mass ratio of (7-9):(3-1);
optionally, raw materials of the magnetic slurry comprise by weight:
1000 parts of the composite soft magnetic alloy powder,
25-40 parts of epoxy resin,
75-100 parts of an organic solvent, and
6-10 parts of a curing agent;
optionally, the epoxy resin comprises bisphenol A epoxy resin or bisphenol F epoxy resin;
optionally, the epoxy resin has an epoxy equivalent of 180-190 g/eq;
optionally, the epoxy resin has a viscosity of 11000-13000 Mpa·s at room temperature;
optionally, the organic solvent comprises any one or a combination of at least two of ethyl acetate, n-propanol, isopropanol or ethanol, preferably a combination of ethyl acetate and n-propanol;
optionally, the curing agent comprises any one or a combination of at least two of ethylenediamine, diethylenetriamine, diethyltoluenediamine or dicyandiamide, preferably diethyltoluenediamine;
optionally, a mixing method of the magnetic slurry comprises ball milling;
optionally, a medium of the ball milling comprises zirconium balls;
optionally, the zirconium balls comprise a zirconium ball with a diameter of 15-20 mm and a zirconium ball with a diameter of 5-10 mm;
optionally, the magnetic slurry has a viscosity of 10000-15000 Mpa·s.

5. The preparation method according to claim 1, wherein the drying in step (2) is performed at 60-100° C.;
optionally, the drying in step (2) is performed for 3-6 h.

6. The preparation method according to claim 1, wherein a specific method for preparing the casting magnetic sheet in step (3) comprises: coating a magnetic slurry on a base film by a casting machine, and then drying, and separating the dried magnetic slurry from the base film to form the casting magnetic sheet;
optionally, the base film comprises a PET base film;
optionally, a manner of the drying comprises baking;
optionally, the baking is performed at 30-120° C.;
optionally, the casting magnetic sheet has a thickness of 0.05-0.5 mm.

7. The preparation method according to claim 1, wherein the first structure in step (3) is subjected to vacuum sealing before the warm-water pressing;
optionally, the warm-water pressing in step (3) is performed at 70-90° C.;
optionally, the warm-water pressing in step (3) is performed at 20-40 MPa;
optionally, the warm-water pressing in step (3) is performed for 30-60 min;
optionally, the curing treatment in step (3) is performed at 140-220° C.;
optionally, the curing treatment in step (3) is performed for 2-4 h.

8. The preparation method according to claim 1, wherein cutting lines are printed on the surface of the pouring body before the separation in step (4);
optionally, before the cutting, a UV film is stuck on a side of the second structure which is provided with the casting magnetic sheet.

9. The preparation method according to claim 1, wherein a specific operation of step (5) comprises: coating the surface of an inductor unit, and then assembling an external electrode to obtain a power inductor.

10. A power inductor, wherein the power inductor is prepared by the method according to claim 1.

11. The preparation method according to claim 3, wherein cutting lines are printed on the surface of the pouring body before the separation in step (4), and a specification size of the cutting lines is the same as the gridlines on the surface of the base.
